(19) United States
(12) Patent Application Publication
(10) Pub. No.: US 2014/0245728 A1
(43) Pub. Date: Sep. 4, 2014

(54) Hydraulic Drive System for Work Vehicle

(71) Applicant: Hitachi Construction Machinery Co., Ltd., Bunkyo-ku, Tokyo (JP)

(72) Inventors: Yoshinobu Kobayashi, Tsuchiura-shi (JP); Ryohei Yamashita, Tsuchiura-shi (JP); Takeshi Kobayashi, Tsuchiura-shi (JP)

(21) Appl. No.: 14/352,157

(22) PCT Filed: Oct. 2, 2012
(86) PCT No.: PCT/JP2012/075510

§ 371 Date: Apr. 16, 2014

(30) Foreign Application Priority Data
Oct. 20, 2011 (JP) 2011-230758

(51) Int. Cl. F15B 1/04

(52) U.S. Cl. CPC F15B 1/04
USPC 60/413

(57) ABSTRACT

The aim of the present invention lies in providing a hydraulic drive system for a working vehicle, in which pressure oil can be supplied to an accumulator when a working device is raised, and in which, when the working device is held in a raised state, except during loaded travel, lowering of the working device caused by leakage of pressure oil inside a bottom chamber of a hydraulic cylinder into a hydraulic oil tank through a gap in a control valve can be reliably prevented. When a working device (2) is raised, oil ejected from a main pump (13) is introduced through an accumulator valve (61) to an accumulator (40). Further, when the working device (2) is held in a raised state, except during loaded travel, leakage of pressure oil inside a bottom chamber (11a) of a lift arm cylinder (11) into a hydraulic oil tank (17) through a gap in a control valve (20) for the lift arm is prevented by means of a poppet (71) of a load retention valve (70).

### TECHNICAL FIELD

The present invention relates to a hydraulic drive system for a working vehicle, in which a bottom chamber of a hydraulic cylinder to which pressure oil is supplied when a working device is raised is connected to an accumulator so as to suppress vertical vibration of the working device during loaded travel.

### BACKGROUND ART

In the background art, there is a hydraulic drive system for a working vehicle as disclosed in Patent Literature 1. This hydraulic drive system will be described next. Here, terms described in Patent Literature 1 are expressed inside “( )”.

The hydraulic drive system is provided with a hydraulic cylinder (boom cylinder), a main pump (hydraulic pump) and a control valve. When pressure oil is supplied to a bottom chamber of the hydraulic cylinder, the hydraulic cylinder raises a working device (boom or bucket) of a working vehicle (wheel loader). When pressure oil is supplied to a rod chamber of the hydraulic cylinder, the hydraulic cylinder lowers the working device. The main pump ejects the pressure oil for driving the hydraulic cylinder. The control valve controls the flow of the pressure oil supplied from the main pump to the hydraulic cylinder.

The control valve is a spool valve, which has a bottom chamber side port connected to the bottom chamber of the hydraulic cylinder through a bottom chamber side pipe line, a rod chamber side port connected to the rod chamber of the hydraulic cylinder through a rod chamber side pipe line, a pump port connected to the main pump, and a tank port connected to a hydraulic oil tank. The control valve is arranged to be switchable among a first operating position, a second operating position and a neutral position. The first operating position is a valve position where the pump port is connected to the bottom chamber side port and the rod chamber side port is connected to the tank port. The second operating position is a valve position where the pump port is connected to the rod chamber side port and the bottom chamber side port is connected to the tank port. In the neutral position, both the connection between the pump port and the bottom chamber side port and the connection between the pump port and the rod chamber side port are cut.

Further, the background-art hydraulic drive system includes an accumulator, an on-off valve and an accumulator valve (selector valve). The accumulator is connected to an end portion of a connection pipe line branching from the bottom chamber side pipe line. The on-off valve is provided on the connection pipe line. The accumulator valve is provided on an accumulation bypass pipe which has opposite ends connected to the connection pipe line and which is located to bypass the on-off valve so that the accumulator valve is arranged in parallel with the on-off valve.

The on-off valve is arranged to be switchable between an open position and a closed position. The open position is a valve position where connection between the bottom chamber and the accumulator is established. The closed position is a valve position where the connection between the bottom chamber and the accumulator is cut. The on-off valve is controlled in the open position during the loaded travel in which the working vehicle travels while holding the working device in a raised state.

The accumulator valve is arranged to be switchable between an accumulation position and a closed position. The accumulation position is a valve position on where pressure oil is allowed to flow toward the accumulator in the accumulation bypass pipe line while a reverse flow of the pressure oil is blocked. The closed position is a valve position where the accumulation bypass pipe line is closed to cut the connection between the control valve and the accumulator. The valve position of the accumulator valve is controlled to be the accumulation position when the pressure oil ejected from the main pump is supplied to the bottom chamber through the control valve and the bottom chamber side pipe line and when the pressure in the accumulator is lower than predetermined pressure.

In the background-art hydraulic drive system configured thus, the on-off valve is controlled in the open position during the loaded travel of the working vehicle. Thus, the bottom chamber of the hydraulic cylinder is brought into connection with the accumulator. In this state, load pressure acting on the bottom chamber of the hydraulic cylinder during loaded travel is absorbed by the accumulator. As a result, vertical vibration of the working device in the working vehicle can be suppressed.

When the valve position of the on-off valve is controlled to be the open position, pressure oil flows into the accumulator from the bottom chamber of the hydraulic cylinder till the pressure in the accumulator is equal to the pressure in the bottom chamber of the hydraulic cylinder. Thus, the hydraulic cylinder contracts in accordance with the amount of the pressure oil flowing into the accumulator. The accumulator valve is provided in parallel with the on-off valve in order to reduce the amount of contraction in the hydraulic cylinder on this occasion, that is, the amount of lowering of the working device.

That is, when oil ejected from the main pump is supplied to the bottom chamber of the hydraulic cylinder through the control valve and the bottom chamber side pipe line in order to raise the working device in the state where the valve position of the accumulator valve has been controlled to be the accumulation position, a part of the ejected oil is introduced into the accumulator through the accumulation bypass pipe line so that pressure oil can be accumulated in the accumulator. Accordingly, the pressure oil can be accumulated before the loaded travel of the working vehicle starts after the working device is raised. Thus, it is possible to reduce the amount of the pressure oil flowing into the accumulator from the bottom chamber of the hydraulic cylinder when the valve position of the on-off valve is controlled to be the open position. It is therefore possible to reduce the amount of contraction in the hydraulic cylinder, that is, the amount of lowering of the working device.

### CITATION LIST

### Patent Literature

Patent Literature 1: JP-A-2006-144248

### SUMMARY OF INVENTION

### Technical Problem

In the aforementioned background-art hydraulic drive system, the control valve (operating valve) is a spool valve. In this control valve, there is a gap between a spool and a land on which the spool slides, for the purpose of allowing the spool to slide on the land. To this end, even in the state where the valve position of the control valve has been held in the neutral position, connection between the bottom chamber of the hydraulic cylinder (boom cylinder) and the hydraulic oil tank cannot be cut exactly. Therefore, when load pressure of some magnitude acts on the inside of the bottom chamber of the hydraulic cylinder, the pressure oil leaks into the hydraulic oil tank through the gap in the control valve, with the result that the hydraulic cylinder contracts to lower the working device. An operator who makes operation to set the valve position of the control valve at the neutral position intends to keep the working device in a raised state. For this reason, if the working device is lowered in the state in which the valve position of the control valve is the neutral position, this situation is against the intention of the operator.

The present invention has been developed in consideration of the aforementioned circumstances. An object of the present invention is to provide a hydraulic drive system for a working vehicle, in which pressure oil can be supplied to an accumulator when a working device is raised, an in which, when the working device is held in a raised state, except during loaded travel, lowering of the working device caused by leakage of pressure oil inside a bottom chamber of a hydraulic cylinder into a hydraulic oil tank through a gap in a control valve can be reliably prevented.

### Solution to Problem

In order to attain the foregoing object, a hydraulic drive system for a working vehicle according to the invention is configured as follows.

[1] A hydraulic drive system for a working vehicle according to the invention, includes: a hydraulic cylinder including a bottom chamber to which pressure oil is supplied to raise a working device of the working vehicle, and a rod chamber to which pressure oil is supplied to lower the working device; a main pump which ejects pressure oil for driving the hydraulic cylinder; a control valve which consists of a spool valve having a bottom chamber side port connected to the bottom chamber through a bottom chamber side pipe line, a rod chamber side port connected to the rod chamber through a rod chamber side pipe line, a pump port connected to the main pump, and a tank port connected to a hydraulic oil tank; an accumulator which is connected to an end portion of a connection pipe line branching from the bottom chamber side pipe line; an on-off valve which is provided on the connection pipe line; and an accumulator valve which is provided on an accumulation bypass pipe line which has opposite ends connected to the connection pipe line and which is located to bypass the on-off valve so that the accumulator valve is arranged in parallel with the on-off valve; so that the control valve is arranged to be switchable among a first operating position which is a valve position where the pump port is connected to the bottom chamber side port and the rod chamber side port is connected to the tank port, a second operating position which is a valve position where the pump port is connected to the rod chamber side port and the bottom chamber side port is connected to the tank port, and a neutral position in which both the connection between the pump port and the bottom chamber side port and the connection between the pump port and the rod chamber side port are cut; the on-off valve is arranged to be switchable between an open position which is a valve position where the connection pipe line is opened to connect the bottom chamber to the accumulator, and a closed position which is a valve position where the connection pipe dine is closed to cut the connection between the bottom chamber and the accumulator, the valve position being controlled to be switched toward the open position from the closed position during loaded, travel in which the working vehicle travels while the working device is held in a raised state, the valve position being controlled to be the closed position at any time except during the loaded travel; and the accumulator valve is arranged to be switchable between an accumulation position which is a valve position where pressure oil is allowed to flow toward the accumulator in the accumulation bypass pipe line, and a closed position which is a valve position where the accumulation bypass pipe line is closed to block the pressure oil flowing into the accumulator, the valve position being controlled to be the accumulation position when the pressure oil ejected from the main pump is supplied to the bottom chamber through the control valve and the bottom chamber side pipe line and when pressure in the accumulator is lower than predetermined pressure; wherein: a load retention valve is provided on the bottom chamber side pipe line; and the load retention valve allows pressure oil to flow from the control valve to the bottom chamber through the bottom chamber side pipe line when the valve position of the control valve is the first operating position, allows pressure oil to flow from the bottom chamber to the control valve through the bottom chamber side pipe line when the control valve is in the second operating position, allows pressure oil to flow from the bottom chamber to the accumulator through the connection pipe line when the loaded travel is carried out, and blocks pressure oil flowing from the bottom chamber to the control valve through the bottom chamber side pipe line by means of a poppet when the valve position of the control valve is the neutral position except during the loaded travel.

In the hydraulic drive system for the working vehicle according to the “[1]”, when the working device is to be raised, the valve position of the control valve is switched to the first operating position so that the control valve can be brought into a state where the pump port is connected to the bottom chamber side port and the rod chamber side port is connected to the tank port. In this state, the load retention valve allows pressure oil to flow from the control valve toward the bottom chamber of the hydraulic cylinder. Accordingly, the oil ejected from the main pump passes through the pump port and the bottom chamber side port of the control valve and then passes through the bottom chamber side pipe line so as to be supplied into the bottom chamber of the hydraulic cylinder. In accordance with this, pressure oil in the rod chamber of the hydraulic cylinder passes through the rod chamber side pipe line and the rod chamber side port and the tank port of the control valve so as to be discharged to the hydraulic oil tank. As a result, the hydraulic cylinder extends to raise the working device.

When the working device is raised thus, that is, when the oil ejected from the main pump is supplied to the bottom chamber through the control valve and the bottom chamber side pipe line, the valve position of the accumulator valve is controlled to be the accumulation position as long as the pressure in the accumulator is lower than the predetermined pressure. On this occasion, the accumulator valve allows the pressure oil to flow toward the accumulator in the accumulation bypass pipe line, and blocks the pressure oil flowing in a reverse direction. Accordingly, a part of the pressure oil flowing in the bottom chamber side pipe line is supplied to the accumulator through the accumulation bypass pipe line till the pressure in the accumulator reaches the predetermined pressure or till the valve position of the control valve for the lift arm is not the first operating position anymore. As a result, the accumulator accumulates the pressure oil. That is, the hydraulic drive system for the working vehicle according to the “[1]” can supply pressure oil to the accumulator when the working device is raised.

When the working device is to be held in the raised state except during loaded travel, the valve position of the control valve is held in the neutral position so that the control valve can be brought into a state where both the connection between the Pump port and the bottom chamber side port and the connection between the pump port and the rod chamber side port are cut. In this state, the load retention valve blocks the pressure oil flowing from the bottom chamber of the hydraulic cylinder toward the control valve by means of the poppet. As a result, the hydraulic cylinder is held in an extending state so as to hold the working device in the raised state. That is, in the hydraulic drive, system for the working vehicle according to the “[1]”, due to the poppet which blocks the pressure oil flowing from the bottom chamber of the hydraulic cylinder toward the control valve, the lowering of the working device caused by leakage of the pressure oil inside the bottom chamber of the hydraulic cylinder into the hydraulic oil tank through the gap in the control valve can be reliably prevented when the working device is held in the raised state except during the loaded travel.

When the working device is to be lowered, the valve position of the control valve is switched to the second operating position so that the control valve can be brought into a state where the pump port is connected to the rod chamber side port and the bottom chamber side port is connected to the tank port. In this state, the load retention valve allows pressure oil to flow from the bottom chamber of the hydraulic cylinder toward the control valve. Accordingly, the oil ejected from the main pump passes through the pump port and the rod chamber side port of the control valve and then passes through the rod chamber side pipe line so as to be supplied into the rod chamber of the hydraulic cylinder. In accordance with this, pressure oil in the bottom chamber of the hydraulic cylinder passes through the bottom chamber side pipe line and the bottom chamber side port and the tank port of the control valve so as to be discharged to the hydraulic oil tank. As a result, the hydraulic cylinder contracts to lower the working device.

When the working vehicle carries out loaded travel, the valve position of the control valve is held in the neutral position so that the control valve can be brought into a state where both the connection between the pump port and the bottom chamber side port and the connection between the pump port and the rod chamber side port are cut. In this state, the on-off valve is controlled to be the open position, and the load retention valve allows the pressure oil to flow from the bottom chamber of the hydraulic cylinder toward the accumulator through the connection pipe line. As a result, load pressure acting on the bottom chamber of the hydraulic cylinder during the loaded travel is absorbed by the accumulator so that vertical vibration of the working device can be suppressed.

When the valve position of the on-off valve is controlled to be the open position, the pressure oil flows into the accumulator from the bottom chamber of the lift arm cylinder till the pressure in the accumulator becomes equal to the pressure in the bottom chamber of the lift arm cylinder. Thus, the lift arm cylinder contracts in accordance with the amount of the pressure oil flowing into the accumulator. When the working device is raised as described previously, a part of the oil ejected from the main pump is supplied to the accumulator. Therefore, the pressure oil is accumulated in the accumulator before the wheel loader starts the loaded travel after the lift arm cylinder extends to raise the working device. Thus, it is possible to reduce the amount of contraction in the lift arm cylinder, that is, the amount of lowering of the lift arm immediately after the valve position of the on-off valve is controlled to be the open position.

[2] A hydraulic drive system for a working vehicle according to the invention is a hydraulic drive system for a working vehicle according to the “[1]”, wherein: the load retention valve includes a return spring which urges the poppet to close, a first open-side pressure chamber in which pressure to open the poppet against an elastic force of the return spring is introduced from the bottom chamber side port of the control valve, a second open-side pressure chamber in which pressure to open the poppet against an elastic force of the return spring is introduced from the bottom chamber side of the hydraulic cylinder, and a closed-side pressure chamber in which oil pressure to press the poppet to close the poppet introduced between the load retention valve and the bottom chamber in the bottom chamber side pipe line; and a selector valve is provided between the bottom chamber side pipe line and the closed-side pressure chamber of the load retention valve, and the selector valve includes a first port connected to the bottom chamber side pipe line between the load retention valve and the bottom chamber, a second port connected to the closed-side pressure chamber, and a tank port connected to the hydraulic oil tank and is arranged to be switchable between a supply position which is a valve position where the first port is connected to the second port while pressure oil flowing toward the tank port from the first and second ports is blocked by the poppet, and a discharge position which is a valve position where the second port is connected to the tank port, the valve position of the selector valve being controlled to be the supply position when the valve position of the control valve is the neutral position except during the loaded travel or when the valve position of the control valve is the first operating position, the valve position of the selector valve being controlled to be the discharge position during the loaded travel or when the valve position of the control valve is the second operating position.

Description will be made about the relationship between the operation of the selector valve and the operation of the load retention valve in the hydraulic drive system for the working vehicle according to the “[2]”.

When the working device is to be raised, the valve position of the control valve is switched to the first operating position so that the control valve can be brought into a state where the pump port is connected to the bottom chamber side port and the rod chamber side port is connected to the tank port. In this state, the valve position of the selector valve is control led to be the supply position. Accordingly, the pressure in the bottom chamber of the hydraulic cylinder is introduced into the closed-side pressure chamber through a part of the bottom chamber side pipe line lying between the load retention valve and the bottom chamber, and the first port and the second port of the selector valve, so as to press the poppet to close the poppet together with the return spring. On the other hand, the discharge pressure of the main pump is introduced into the first open-side pressure chamber through a part of the bottom chamber side pipe line lying between the control valve and the load retention valve, so as to press the poppet to open the poppet. The force with which the discharge pressure of the main pump introduced into the first open-side pressure chamber presses the poppet to open the poppet presses and retracts the poppet against the pressure in the bottom chamber of the hydraulic cylinder introduced into the closed-side pressure chamber and the force with which the return spring presses the poppet to close the poppet. Thus, the load retention valve is opened. That is, the load retention valve allows the pressure oil to flow from the control valve toward the bottom chamber of the hydraulic cylinder through the bottom chamber side pipe line.

When the working device is to be lowered, the valve position of the control valve is switched to the second operating position so that the control valve can be brought into a state where the pump port is connected to the rod chamber side port and the bottom chamber side port is connected to the tank port. In this state, the valve position of the selector valve is control led to be the discharge position. Accordingly, the pressure in the closed-side pressure chamber of the load retention valve is discharged to the hydraulic oil tank through the second port and the tank port of the selector valve. On the other hand, the oil ejected from the main pump passes through the pump port and the rod chamber side port of the control valve and then passes through the rod chamber side pipe line so as to be supplied into the rod chamber of the hydraulic cylinder. In accordance with this, the pressure in the bottom chamber of the hydraulic cylinder is introduced into the second open-side pressure chamber of the load retention valve so as to press and retract the poppet against the elastic force of the lift arm cylinder. Thus, the load retention valve is opened. That is, the load retention valve allows the pressure oil to flow from the bottom chamber of the hydraulic cylinder toward the control valve through the bottom chamber side pipe line.

When the working device is to be held in the raised state except during loaded travel, the valve position of the control valve is held in the neutral position so that the control valve can be brought into a state where both the connection between the pump port and the bottom chamber side port and the connection between the pump port and the rod chamber side port are cut. In this state, the valve position of the selector valve is controlled to be the supply position. Thus, the pressure in the bottom chamber of the hydraulic cylinder is introduced into the closed-side pressure chamber through a part of the bottom chamber side pipe line lying between the load retention valve and the bottom chamber, and the first port and the second port of the selector valve, so as to press the poppet to close the poppet together with the return spring. The pressure in the bottom chamber of the hydraulic cylinder is also introduced into the second open-side pressure chamber of the load retention valve through the part of the bottom chamber side pipe line lying between the load retention valve and the bottom chamber of the hydraulic cylinder, so that the pressure can press the poppet to open the poppet. On the other hand, the connection between the load retention valve and the main pump is cut by the control valve so that the discharge pressure of the main pump cannot be introduced into the first open-side pressure chamber of the load retention valve. Due to the pressure in the closed-side pressure chamber and the return spring, the poppet is pressed to close against the pressure in the bottom chamber of the hydraulic cylinder introduced into the second open-side pressure chamber, so that the load retention valve can be held in the closed state. That is, the load retention valve blocks the pressure oil flowing from the bottom chamber of the hydraulic cylinder toward the control valve through the bottom chamber side pipe line by means of the poppet.

When the working vehicle carries out loaded travel, the valve position of the control valve is held in the neutral position so that the control valve can be brought into a state where both the connection between the pump port and the bottom chamber side port and the connection between the pump port and the rod chamber side port are cut. In this state, the valve position of the selector valve is controlled to be the discharge position. In accordance with this, the pressure in the closed-side pressure chamber of the load retention valve is discharged to the hydraulic oil tank through the second port and the tank port of the selector valve. On this occasion, the pressure in the bottom chamber of the hydraulic cylinder is introduced into the second open-side pressure chamber of the load retention valve through a part of the bottom chamber side pipeline lying between the load retention valve and the bottom chamber of the hydraulic cylinder. Thus, the pressure in the bottom chamber of the lift arm cylinder introduced into the second open-side pressure chamber presses and retracts the poppet against the return spring, so as to open the load retention valve. On the other hand, the on-off valve is controlled in the open position while the valve position of the control valve is the neutral position so as to cut the connection between the main pump and the load retention valve. Therefore, when the load retention valve is opened, the pressure oil in the bottom chamber of the hydraulic cylinder is introduced into the accumulator through the load retention valve and the connection pipe line. That is, the load retention valve allows the pressure oil to flow from the bottom chamber of the hydraulic cylinder toward the accumulator through the connection pipe line.

In the hydraulic drive system for the working vehicle according to the “[2]”, when the working device is to be raised or when the working device is held in the raised state except during the loaded travel, the poppet in the selector valve blocks the pressure oil flowing from the first port toward the tank port and the pressure oil flowing from the second port toward the tank port, so that the pressure in the bottom chamber of the hydraulic cylinder can be introduced into the closed-side pressure chamber of the load retention valve to thereby act on the poppet without leaking. Accordingly, it is possible to hold the poppet of the load retention valve surely in the closed state. Thus, it is possible to contribute to prevention of the pressure oil from leaking from the load retention valve to the control valve for the lift arm.

### Advantageous Effects of Invention

In the hydraulic drive system for the working vehicle according to the present invention, pressure oil ejected from the main pump can be supplied to the accumulator through the accumulator valve when the working device is raised. Thus, it is possible to reduce the amount of lowering of the working device immediately after the valve position of the on-off valve is controlled to be the open position during loaded travel.

In addition, in the hydraulic drive system for the working vehicle according to the present invention, lowering of the working device caused by leakage of pressure oil inside the bottom chamber of the lift arm cylinder into the hydraulic oil tank through the gap in the control valve for the lift arm can be reliably prevented by the poppet of the load retention valve when the working device is held in the raised state except during the loaded travel. Thus, it is possible to prevent the working device from lowering against the intention of the operator.

### BRIEF DESCRIPTION OF DRAWINGS

A side view of a wheel loader which is a working vehicle according to one embodiment of the invention.

A hydraulic circuit diagram showing a hydraulic drive system according the embodiment of the invention.

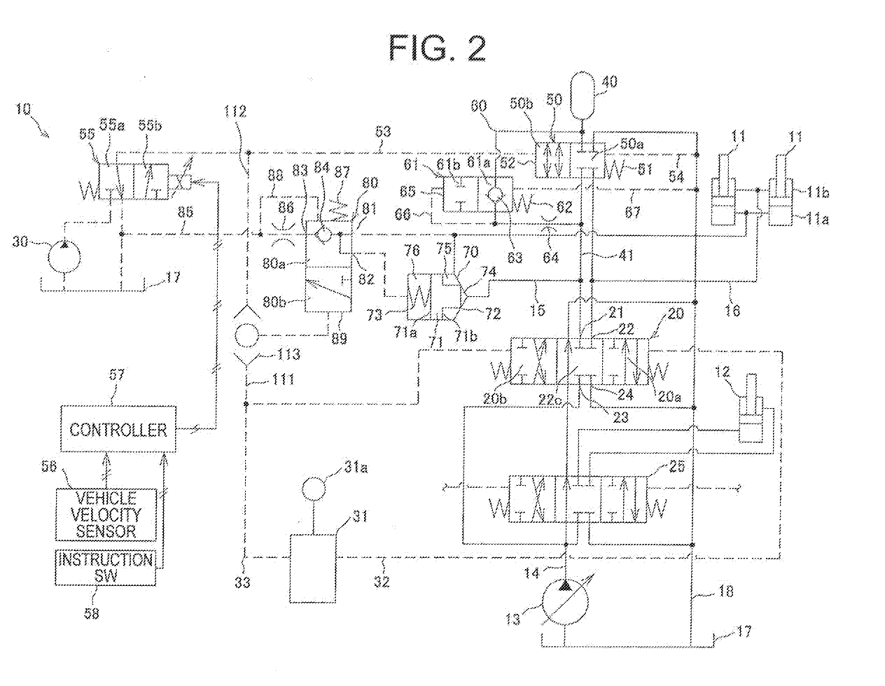

A characteristic graph showing the relation between a control current applied to an on-off control valve shown in FIG. 2 and the opening degree of the on-off valve.

A characteristic graph showing the relation between elapsed time for which the vehicle velocity has been within a specified range of the vehicle velocity during loaded travel and a value of a current applied to the on-off control valve.

A flow chart showing a process carried out when a controller shown in FIG. 2 controls the on-off control valve.

### DESCRIPTION OF EMBODIMENT

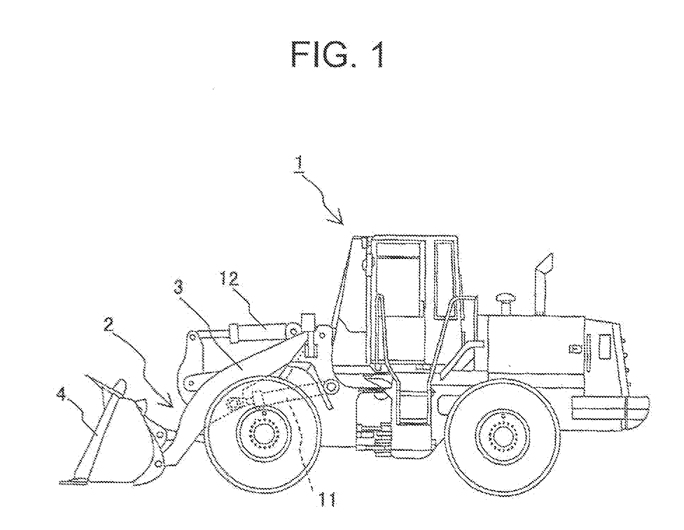

A hydraulic drive system for a working vehicle according to one embodiment of the invention will be described with reference to FIGS. 1 to 5.

The hydraulic drive system according to the embodiment is, for example, applied to a working vehicle shown in FIG. 1, that is, a wheel loader 1. A working device 2 of the wheel loader 1 has a lift arm 3 which is provided in a front portion of a vehicle body so as to be vertically rotatable, and a bucket 4 which is provided in a front end of the lift arm 3 so as to be vertically rotatable. The lift arm 3 and the bucket 4 are driven by a lift arm cylinder 11 (hydraulic cylinder) and a bucket cylinder 12 (hydraulic cylinder) respectively.

As shown in FIG. 2, a hydraulic drive system 10 according to the embodiment has the lift arm cylinder 11, the bucket cylinder 12, a main pump 13 (variable displacement type hydraulic pump) which ejects pressure oil to be supplied to the lift arm cylinder 11 and the bucket cylinder 12, a lift arm control valve 20 which controls the flow of pressure oil supplied from the main pump 13 to the lift arm cylinder 11 between the main pump 13 and the lift arm cylinder 11, and a bucket control valve 25 which controls the flow of pressure oil supplied from the main pump 13 to the bucket cylinder 12 between the main pump 13 and the bucket cylinder 12. The lift arm control valve 20 and the bucket control valve 25 are provided on a bypass pipe line 14 and connected in parallel to each other with respect to the bypass pipe line 14.

The lift arm cylinder 11 is a single rod type double acting cylinder. The lift arm cylinder 11 includes a bottom chamber 11a which is a pressure chamber formed on the bottom side of a cylinder tube, and a rod chamber 11b which is a pressure chamber formed on the rod side of a piston. When pressure oil is supplied to the bottom chamber 11a, the lift arm cylinder 11 extends to rotate the lift arm 3 upward to thereby raise the bucket 4. When pressure oil is supplied to the rod chamber 11b, the lift arm cylinder 11 contracts to rotate the lift arm 3 downward to thereby lower the bucket 4. In the following description, raising of the working device 2 will mean that the lift arm 3 is rotated upward to raise the bucket 4, and lowering of the working device 2 will mean that the lift arm 3 is rotated downward to lower the bucket 4.

The lift arm control valve 20 consists of a spool valve. The lift arm control valve 20 includes a bottom chamber side port 21, a rod chamber side port 22, a pump port 23, and a tank port 24. The bottom chamber side port 21 is connected to the bottom chamber 11a of the lift arm cylinder 11 through a bottom chamber side pipe line 15. The rod chamber side port 22 is connected to the rod chamber 11b of the lift arm cylinder 11 through a rod chamber side pipe line 16. The pump port 23 is connected to the main pump 13. The tank port 24 is connected to a hydraulic oil tank 17. The lift arm control valve 20 is a hydraulic pilot type and spring center type three-position valve, which is arranged to be switchable among a first operating position 20a (right valve position in FIG. 2), a second operating position 20b (left valve position in FIG. 2) and a neutral position 20c (central valve position in FIG. 2). The first operating position 20a is a valve position where the pump port 23 is connected to the bottom chamber side port 21 and the rod chamber side port 22 is connected to the tank port 24. The second operating position 20b is a valve position where the pump port 23 is connected to the rod chamber side port 22 and the bottom chamber side port 21 is connected to the tank port 21. In the neutral position on 20c, both the connection between the pump port 23 and the bottom chamber side port 21 and the connection between the pump port 23 and the rod chamber side port are cut.

The hydraulic drive system 10 is further provided with a pilot pump 30, and an operation lever unit 31 for generating pilot pressure from the discharge pressure of the pilot pump 30. The operation lever unit 31 has an operation lever 31a which can be operated to tilt in two opposite directions from an initial position. When the operation lever 31a is operated to tilt in one direction from the initial position, pilot pressure for extension is generated to change the valve position of the lift arm control valve 20 from the neutral position 20c to the first operating position 20a. When the operation lever 31a is operated to tilt in the other direction opposite to the one direction from the initial position, pilot pressure for contraction is generated to switch the valve position of the lift arm control valve 20 from the neutral position 20c to the second operating position 20b. The pilot pressure for extension is introduced to the lift arm control valve 20 through a pilot pipe line 32 for extension. The pilot pressure for contraction is introduced to the lift arm control valve 20 through a pilot pipe line 33 for contraction.

The bucket cylinder 12 is a single rod type double acting cylinder the same as the lift arm cylinder 11. The bucket control valve 25 is a spool valve, which is a hydraulic pilot type and spring center type three-position valve in the same manner as the lift arm control valve 20. The connection relation between the bucket control valve 25 and the bucket cylinder 12 is similar to the connection relation between the lift arm control valve 20 and the lift arm cylinder 11. The illustration of an operation lever unit for generating pilot pressure for the bucket control valve 25 is omitted.

The hydraulic drive system 10 is further provided with an accumulator 40, a return pipe line 18, and an on-off valve 50. The accumulator 40 is connected to an end portion of a connection pipe line 41 branching from the bottom chamber side pipe line 15. The return pipe line 18 is provided to branch from the rod chamber side pipe line 16 and extend to the hydraulic oil tank 17. The on-off valve 50 is provided to lie across the connection pipe line 41 and the return pipe line 18 so as to open and close the connection pipe line 41 and the return pipe line 18. The on-off valve 50 is a hydraulic pilot type and spring return type two-position valve. The on-off valve 50 is arranged so that the valve position of the on-off valve 50 can be changed between a closed position 50a (right, valve position in FIG. 2) and an open position 50b (left valve position in FIG. 2). The closed position 50a is a normal position defined by a return spring 51. The closed position 50a is a valve position where both the connection pipe line 41 and the return pipe line 18 are closed. The open position 50b is an operating position, which is a valve position where both the connection pipe line 41 and the return pipe line 18 are opened. Pilot pressure to open the on-off valve 50 is applied to a pressure receiving surface 52 of the on-off valve 50 through a valve opening pilot pipe line 53. A drain pipe line 54 extending from the return spring 51 side of the on-off valve 50 is connected to the return pipe line 18.

The hydraulic drive system 10 is further provided with an on-off control valve 55 which is a spring return type proportional electromagnetic valve connected to the valve opening pilot pipe line 53 and by which the pilot pressure to be applied to the pressure receiving surface 52 of the on-off valve 50 is generated from the discharge pressure of the pilot pump 30. The on-off control valve 55 can change its valve position between a normal position 55a and an operating position 55b so that higher pilot pressure can be generated as the valve position is changed more toward the operating position 55b from the normal position 55a.

The hydraulic drive system 10 is further provided with a vehicle velocity sensor 56, a controller 57, and an instruction switch 58 (instruction SW). The vehicle velocity sensor 56 detects the vehicle velocity of the wheel loader 1 and outputs a vehicle velocity detection signal (electric signal) in accordance with the vehicle velocity. The controller 57 controls the on-off control valve 55 based on the vehicle velocity detection signal outputted from the vehicle velocity sensor 56. The instruction switch 58 outputs, to the controller 57, an instruction signal corresponding to an instruction to operate the on-off control valve 55.

Upon reception of the instruction signal from the instruction switch 58, the controller 57 determines whether the vehicle velocity is within a specified range for loaded travel or not. The controller 57 is set to supply a control current to the on-off control valve 55 and operate the on-off control valve 55 when the vehicle velocity is within the specified range as a result of the determination. The specified range of the vehicle velocity for the loaded travel is set in advance as a range of vehicle velocity suitable for travel (loaded travel) in a state where the bucket 4 is loaded with a cargo.

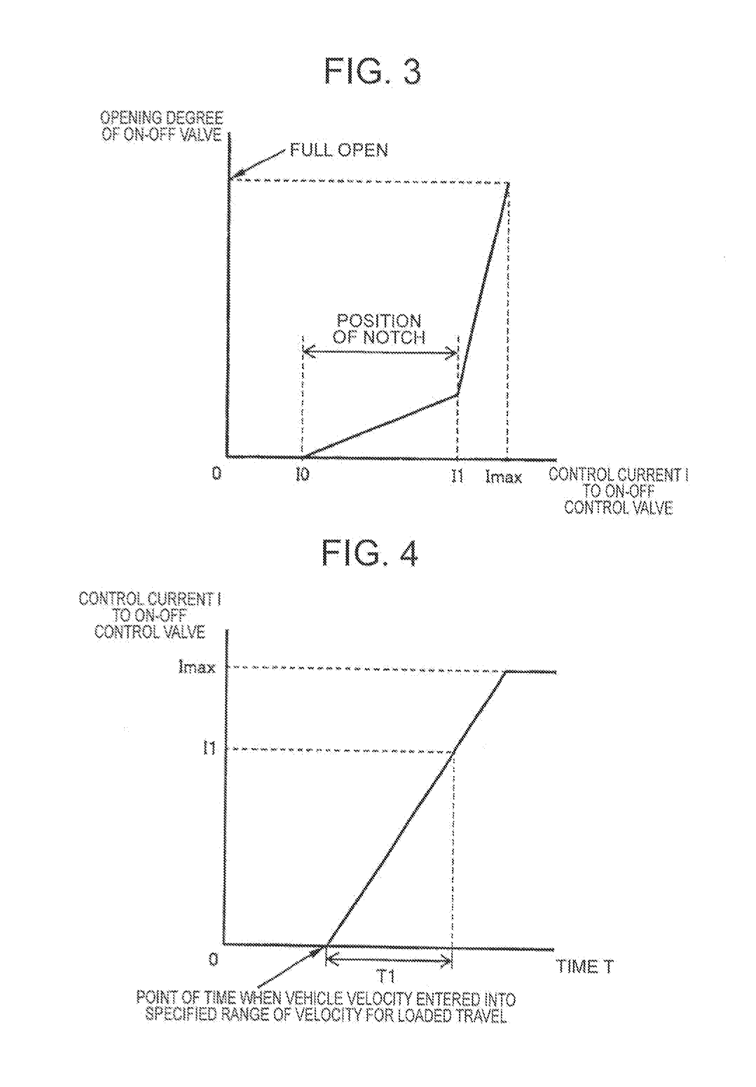

A current value I of the control current to be applied to the on-off control valve 55 is calculated by a CPU, a ROM and a RAM provided in the controller 57. The relation between the current value I of the control current and the opening degree of the on-off valve 50 (on-off valve opening) is set so that the opening degree of the on-off valve 50 increases with the increase of the current value I of the control current as shown in FIG. 3. Incidentally, a notch (not shown) is provided in a valve body of the on-off valve 50. In a first range where the range of the current value I of the control current is set as “I0≦I≦I1”, the opening degree of the on-off valve 50 is changed in accordance with the effect of the notch. In a second range where the range of the control current is set as “I1<I≦Imax”, the opening degree of the on-off valve 50 is changed within a range beyond the position of the notch. Due to the notch, the rate of change in the opening degree of the on-off valve 50 in the first range is set to be smaller than the rate of change in the opening degree of the on-off valve 50 in the second range. Thus, fine adjustment of the opening degree of the on-off valve 50 in the first range can be performed easily than that in the second range.

In addition, after the vehicle velocity enters into the specified range for loaded travel, the relation between the vehicle velocity of the wheel loader 1 and the current value I of the control current is set as shown in FIG. 4 so that the control current I can increase to reach a current value I1 in proportion to an elapsed time till a time T1 has passed since the entrance of the vehicle velocity into the specified range.

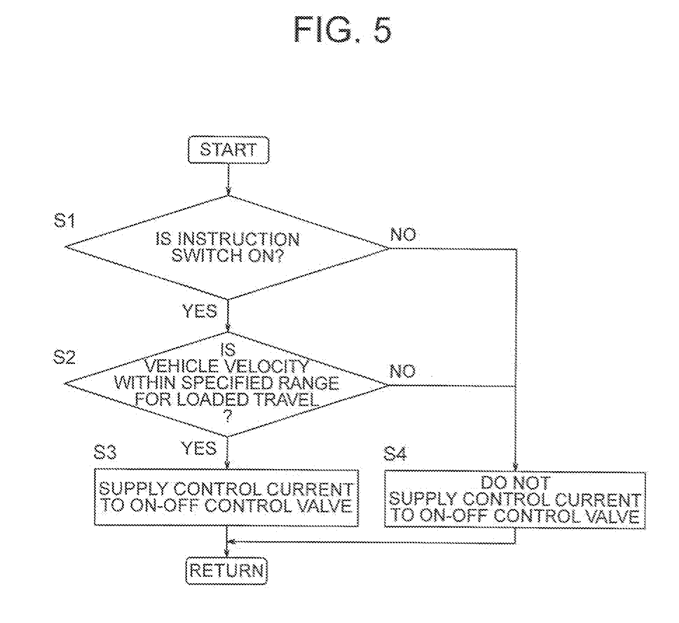

The controller 57 is set to control the on-off control valve 55 in the procedure shown in FIG. 5. That is, when the instruction switch 58 turns ON so that an instruction signal is inputted to the controller 57 (YES in Step S1), the controller 57 determines whether the vehicle velocity of the wheel loader is within the specified range for loaded travel or not based on the vehicle velocity detection signal from the vehicle velocity sensor 56 (Step S2). When the vehicle velocity is within the specified range of the vehicle velocity for loaded travel as a result of the determination (YES in Step S2), a control current is supplied to the on-off control valve 55 (Step S3). The routine from Step S1 to Step S3 is repeated as long as the state where the vehicle velocity is within the specified range for loaded travel is kept in the ON state of the instruction switch 58. In the meantime, the state where the valve position of the on-off valve 50 has been changed from the closed position 50a toward the open position 50b is kept.

When the instruction switch 58 is OFF (NO in Step S1) or when the vehicle velocity is not within the specified range for loaded travel (NO in Step S2), the controller 57 supplies no current to the on-off control valve 55 (Step S4). Thus, the on-off valve 50 is controlled in the closed position 50a by the return spring 51 as to as the instruction switch 58 is OFF or as long as the state where the vehicle velocity is not within the specified range for loaded travel is kept.

That is, the on-off valve 50 is controlled by the valve opening pilot pipe line 53, the pilot pump 30, an open control valve 80, the instruction switch 58, the vehicle velocity sensor 56 and the controller 57 so that the valve position of the on-off valve 50 can be the open position 50b when the wheel loader 1 carries out loaded travel. On the other hand, except during loaded travel, the on-off valve 50 is controlled by the return spring 51 so that the valve position can be the closed position 50a.

The hydraulic drive system 10 is further provided with an accumulator valve 61 which is provided on an accumulation bypass pipe line 60 so as to be arranged in parallel with the on-off valve 50. The bypass pipe line 60 has opposite ends connected to the connection pipe line 41 and is located to bypass the on-off valve 50. The accumulator valve 61 is a hydraulic pilot type and spring return type two-position valve. The accumulator valve 61 has its valve position set between an accumulation position on 61a and a closed position 61b. The accumulation position 61a is a normal position defined by a return spring 62. The accumulation position 61a is a valve position where a check valve 63 is used to allow pressure oil to flow toward the accumulator 40 in the accumulation bypass pipe line 60 and block pressure oil to flow in a reverse direction thereto. The closed position 61b is an operating position, which is a valve position where the accumulation bypass pipe line 60 is closed to block the connection between the lift arm control valve 20 and the accumulator 40.

In the accumulation bypass pipe line 60, a throttle 64 is provided between the accumulator valve 61 and an end portion of the accumulation bypass pipeline 60 connected to the bottom chamber side pipe line 15 side of the connection pipe line 41 with respect to the on-off valve 50. An accumulation stopping pilot pipe line 66 is provided to branch from a place between the throttle 64 and the accumulator valve 61 so that the pressure at the place can be applied to a pressure receiving surface 65 of the accumulator valve 61 as pilot pressure. The pressure in the accumulator 40 is applied to the pressure receiving surface 65 of the accumulator valve 61 by the throttle 64 and the accumulation stopping pilot pipe line 66. A drain pipe line 67 extending from the return spring 62 side of the accumulator valve 61 is connected to the return pipe line 18.

The accumulator valve 61 is controlled to take its valve position in the accumulation position 61a when the pressure in the accumulator 40 is lower than predetermined pressure. The predetermined pressure is defined by a set load of the return spring 62. On the assumption that load pressure acts on the bottom chamber 11a of the lift arm cylinder 11 during loaded travel, the predetermined pressure is set to switch the valve position of the accumulator valve 61 to the closed position 61b when the load pressure is substantially equal to the pressure in the accumulator 40.

The hydraulic drive system 10 is further provided with a load retention valve 70 on the bottom chamber side pipe line 15. The load retention valve 70 is a spring return type poppet valve for opening and closing the bottom chamber side pipe line 15. The load retention valve 70 includes a poppet 71, a valve seat 72, a return spring 73, a first open-side pressure chamber 74, a second open-side pressure chamber 75, and a closed-side pressure chamber 76. The valve seat 72 abuts against the poppet 71. The return spring 73 urges the poppet 71 toward the valve seat 72, that is, in a direction to close the poppet 71. In the first open-side pressure chamber 74, pressure to open the poppet 71 against an elastic force of the return spring 73 is introduced from the bottom chamber side port 21 side of the lift arm control valve 20. In the second open-side pressure chamber 75, pressure to open the poppet 71 against the elastic force of the return spring 73 is introduced from the bottom chamber 11a side of the lift arm cylinder 11. In the closed-side pressure chamber 76, pressure oil to press the poppet 71 to close the poppet 71 is introduced between the load retention valve 70 and the bottom chamber 11a of the lift arm cylinder 11 in the bottom chamber side pipe line 15. A closed-side pressure receiving surface 71a of the poppet 71 for receiving pressure in the closed-side pressure chamber 76 is set to be larger than an open-side pressure receiving surface 71b of the poppet 71 for receiving pressure in the second open-side pressure chamber 75. The closed-side pressure chamber 76 also serves as a spring chamber in which the return spring 73 is received.

The hydraulic drive system 10 is further provided with a selector valve 80 which is provided between the bottom chamber side pipe line 15 and the closed-side pressure chamber 76 of the load retention valve 70. The selector valve 80 includes a first port 81, a second port 82 and a tank port 83. The first port 81 is connected to the bottom chamber side pipe line 15 between the load retention valve 70 and the bottom chamber 11a of the lift arm cylinder 11. The second port 82 is connected to the closed-side pressure chamber 76. The tank port 83 is connected to the hydraulic oil tank 17. The selector valve 80 is a spring return type two-position valve. The selector valve 80 is arranged to be switchable between a supply position 80a (normal position) and a discharge position 80b (operating position). The supply position 80a is a valve position where the first port 81 is connected to the second port 82 while pressure oil flowing toward the tank port 83 from the first port 81 and the second port 82 is blocked by a poppet 84. The discharge position 80b is a valve position where the second port 82 is connected to the tank port 83. A throttle 86 is provided in a return pipe line 85 which connects the tank port 83 of the selector valve 80 to the hydraulic oil tank 17. A drain pipe line 88 extending from the return spring 87 side of the selector valve 80 is connected to the hydraulic oil tank 17 side of the return pipe line 85 with respect to the throttle 86.

The hydraulic drive system 10 is further provided with a first retained pressure discharging pilot pipe line 111, a second retrained pressure discharging pilot line 112, and a high pressure selecting value 113 (high pressure priority type shuttle valve). The first retained pressure discharging pilot pipe line 111 branches from the contraction pilot pipe line 33. The second retained pressure discharging pilot pipe line 112 branches from the valve opening pilot pipe line 53. The high pressure selecting valve 113 selects a higher one of the pressure in the first retained pressure discharging pilot pipe line ill and the pressure in the second retained pressure discharging pilot pipe line 112 as pilot pressure and introduces the selected pressure to a pressure receiving surface 89 of the selector valve 80.

That is, in the state where no pilot pressure is generated by the on-off control valve 55, that is, in any state except during loaded travel, the valve position of the selector valve 80 is controlled to be the supply position 80a by the return spring 87 when the operation lever 31a is not operated to tilt or when the operation lever 31a is operated to tilt to thereby generate pilot pressure for extension, that is, when no pilot pressure for contraction is generated by the operation lever unit 31, further in other words, when the valve position of the lift arm control valve 20 is the neutral position 20c or when the valve position of the lift arm control valve is the first operating position 20a. On the other hand, when the operation lever unit 31 generates pilot pressure for contraction in the same state, that is, when the valve position of the lift arm control valve 20 is the second operating position 20b in the same state, the pilot pressure for contraction is introduced to the pressure receiving surface 89 of the selector valve 80 through the first retained pressure discharging pilot pipe line 111 and the high pressure selecting valve 113 so that the valve position of the selector valve 80 can be controlled to be the discharge position 80b against the elastic force of the return spring 87.

On the other hand, in the state where pilot pressure is generated by the on-off control valve 55, that is, in the state of loaded travel, the pilot pressure generated by the on-off control valve 55 is introduced to the pressure receiving surface 89 of the selector valve 80 through the second retained pressure discharging pilot pipe line 112 and the high pressure selecting valve 113 so that the valve position of the selector valve 80 can be controlled to be the discharge position 30b against the elastic force of the return spring 87.

Operations of the hydraulic drive system 10 according to the embodiment will be described along the following (1) to (4).

(1) First, an operation of the hydraulic drive system 10 for raising the working device 2 the state where the wheel loader 1 is not driven to travel will be described.

In this case, an operator of the wheel loader 1 operates the operation lever 31a so that pilot pressure for extension can be given to the lift arm control valve 20 from the operation lever unit 31 so as to switch the valve position of the lift arm control valve 20 to the first operating position 20a. Thus, the lift arm control valve 20 is brought into a state where the pump port 23 is connected to the bottom chamber side port 21 and the rod chamber side port 22 is connected to the tank port 24.

In addition, the operator does not turn on the instruction switch 58. Further, the vehicle velocity detection signal outputted from the vehicle velocity sensor 56 designates a vehicle velocity out of the specified range for loaded travel. Therefore, the controller 57 is in a state where it gives no control current to the on-off control valve 55. That is, the on-off control valve 55 is in a state where it generates no pilot pressure.

In these states, no pilot pressure for contraction is given to the selector valve 80 through the first retained pressure discharging pilot pipe line 111 and the high pressure selecting valve 113, and no pilot pressure is given to the selector valve 80 through the second retained pressure discharging pilot pipe line 112 and the high pressure selecting valve 113. Accordingly, the valve position of the selector valve 80 is controlled to be the supply position 80a by the return spring 87. Thus, the pressure in the bottom chamber 11a of the lift arm cylinder 11 is introduced into the closed-side pressure chamber 76 through a part of the bottom chamber side pipe line 15 lying between the load retention valve 70 and the bottom chamber 11a, and the first port 81 and the second port 82 of the selector valve 80, so as to press the poppet 71 to close the poppet 71 together with the return spring 73. On the other hand, the discharge pressure of the main pump 13 is introduced into the first open-side pressure chamber 74 through a part of the bottom chamber side pipe line 15 lying between the lift arm control valve 20 and the load retention valve 70 so as to press the poppet 71 to open the poppet 71. The force with which the discharge pressure of the main pump 13 introduced into the first open-side pressure chamber 74 presses the poppet 71 to open the poppet 71 presses and retracts the poppet 71 against the force with which the pressure in the bottom chamber 11a of the lift arm cylinder 11 introduced into the closed-side pressure chamber 76 and the return spring 73 press the poppet 71 to close the poppet 71. Thus, the load retention valve 70 is opened. That is, the load retention valve 70 allows pressure oil to flow from the lift arm control valve 20 toward the bottom chamber 11a of the lift arm cylinder 11 through the bottom chamber side pipe line 15. In accordance with this, the oil ejected from the main pump 13 and passing through the pump port 23 and the bottom chamber side port 21 of the lift arm control valve 20 is supplied to the bottom chamber 11b of the lift arm cylinder 11 through the bottom chamber side pipe line 15. In parallel with this, pressure oil in the rod chamber 11b of the lift arm cylinder 11 is discharged to the hydraulic oil tank 17 through the rod chamber side pipe line 16 and the rod chamber side port 22 and the tank port 24 of the lift arm control valve 20. As a result, the lift arm cylinder 11 extends to raise the working device 2.

When the working device 2 is raised thus, that is, when the oil ejected from the main pump 13 is supplied to the bottom chamber 11a of the lift arm cylinder 11 through the lift arm control valve 20 and the bottom chamber side pipe line 15, the valve position of the accumulator valve 61 is controlled to be the accumulation position on 61a by the return spring 62 as long as the pressure in the accumulator 40 is lower than predetermined pressure. On this occasion, the accumulator valve 61 uses the check valve 63 to allow pressure oil to flow toward the accumulator 40 in the accumulation bypass pipe line 60, and block pressure oil flowing in a reverse direction thereto. Thus, a part of the pressure oil flowing in the bottom chamber side pipe line 15 is supplied to the accumulator 40 through the accumulation bypass pipe line 60 till the pressure in the accumulator 40 reaches the predetermined pressure or till the valve position of the lift arm control valve 20 is not the first operating position 20a anymore. As a result, the accumulator 40 is in a state where it has accumulated pressure.

(2) Next, an operation of the hydraulic drive system 10 for holding the working device 2 in the raised state except during loaded travel will be described.

In this case, the operator of the wheel loader 1 does not operate the operation lever 31a. Accordingly, the operation lever unit 31 does not give either the pilot pressure for extension or the pilot pressure for contraction to the lift arm control valve 20 so that the valve position of the lift arm control valve 20 is held in the neutral position 20c. Thus, the lift am control valve 20 is brought into a state where both the connection between the pump port 23 and the bottom chamber side port 21 and the connection between the pump port 23 and the rod chamber side port 22 has been cut.

In addition, the operator does not turn on the instruction switch 58. Further, the vehicle velocity detection signal outputted from the vehicle velocity sensor 56 designates a vehicle velocity out of the specified range for loaded travel. Therefore, the controller 57 is in a state where it gives no control current to the on-off control valve 55. That is, the on-off control valve 55 is in a state where it generates no pilot pressure.

In these states, no pilot pressure for contraction is given to the selector valve 80 through the first retained pressure discharging pilot pipe line 111 and the high pressure selecting valve 113, and no pilot pressure is given to the selector valve 80 through the second retained pressure discharging pilot pipe line 112 and the high pressure selecting valve 113. Accordingly, the valve position of the selector valve 80 is controlled to be the supply position 80a by the return spring 87. Thus, the pressure in the bottom chamber 11a of the lift arm cylinder 11 is introduced into the closed-side pressure chamber 76 through the bottom chamber side pipe line 15 lying between the load retention valve 70 and the bottom chamber 11a, and the first port 81 and the second port 82 of the selector valve 80, so as to press the poppet 71 to close the poppet 71 together with the return spring 73. In addition, the pressure in the bottom chamber 11a of the lift arm cylinder 11 is introduced into the second open-side pressure chamber 75 through the part of the bottom chamber side pipe line 15 lying between the load retention valve 70 and the bottom chamber 11a of the lift arm cylinder 11. In addition, the connection between the main pump 13 and the load retention valve 70 is cut by the lift arm control valve 20. Thus, the discharge pressure of the main pump 13 is not introduced into the first open-side pressure chamber 74 of the load retention valve 70. The pressure in the bottom chamber 11a of the lift arm cylinder 11 introduced into the closed-side pressure chamber 76 and the return spring 73 presses the poppet 71 onto the valve seat 72, that is, presses the poppet 71 to close the poppet 71 against the pressure in the bottom chamber 11a of the lift arm cylinder 11 introduced into the second open-side pressure chamber 75. Thus, the load retention valve 70 is held in the closed state. That is, the load retention valve 70 uses the poppet 71 to block pressure oil flowing from the bottom chamber 11a of the lift arm cylinder 11 toward the lift arm control valve 20 through the bottom chamber side pipe line 15. Consequently, the lift arm cylinder 11 is held in the extended state so as to hold the working device 2 in the raised state. In this state, the lowering of the working device 2 caused by leakage of the pressure oil inside the bottom chamber 11a of the lift arm cylinder 11 into the hydraulic oil tank 17 through a gap in the lift arm control valve 20 can be prevented reliably due to the poppet 71 which blocks the flow of the pressure oil.

(3) Next, an operation of the hydraulic drive system 10 for lowering the working device 2 in the state where the wheel loader 1 is not driven to travel will be described.

In this case, the operator of the wheel loader 1 operates the operation lever 31a so as to give pilot pressure for contraction to the lift arm control valve 20 from the operation lever unit 31 to thereby switch the valve position of the lift arm control valve 20 to the second operating position 20b. Thus, the lift arm control valve 20 is brought into a state where the pump port 23 has been connected to the rod chamber side port 22 and the bottom chamber side port 21 has been connected to the tank port 24.

In addition, the operator does not turn on the instruction switch 58. Further, the vehicle velocity detection signal outputted from the vehicle velocity sensor 56 designates a vehicle velocity out of the specified range for loaded travel. Therefore, the controller 57 is in a state where it gives no control current to the on-off control valve 55. That is, the on-off control valve 55 is in a state where it generates no pilot pressure.

In these states, the pilot pressure for contraction generated by the operation lever unit 31 is also given to the selector valve 80 through the first retained pressure discharging pilot pipe line 111 and the high pressure selecting valve 113. Accordingly, the valve position of the selector valve 80 is switched to the discharge position 80b. Thus, the pressure in the closed-side pressure chamber 76 of the load retention valve 70 is discharged to the hydraulic oil tank 17 through the second port 82 and the tank port 83 of the selector valve 80. On the other hand, the oil ejected from the main pump 13 and passing through the pump port 23 and the rod chamber side port 22 of the lift arm control valve 20 is supplied to the rod chamber 11b of the lift arm cylinder 11 through the rod chamber side pipe line 16. In accordance with this, the pressure in the bottom chamber 11a of the lift arm cylinder 11 is introduced into the second open-side pressure chamber 75 of the load retention valve 70 so as to press and retract the poppet 71 against the elastic force of the return spring 73. Thus, the load retention valve 70 is opened. That is, the load retention valve 70 allows pressure oil so flow from the bottom chamber 11a of the lift arm cylinder 11 toward the lift arm control valve 20 through the bottom chamber side pipe line 15. Accordingly, the pressure oil in the bottom chamber 11a of the lift arm cylinder 11 is discharged to the hydraulic oil tank 17 through the bottom chamber side pipe line 15 and the bottom chamber side port 21 and the tank port 24 of the lift arm control valve 20. As a result, the lift arm cylinder 11 contracts to lower the working device 2.

(4) Next, an operation of the hydraulic drive system 10 in the case where the wheel loader 1 is driven to travel while holding the working device 2 in the raised state, that is, in the case where the wheel loader 1 carries out loaded travel will be described.

In this case, the operator of the wheel loader 1 does not operate the operation lever 31a. Accordingly, the operation lever unit 31 does not give either the pilot pressure for extension or the pilot pressure for contraction to the lift arm control valve 20. Thus, the valve position of the lift arm control valve 20 is held in the neutral position 20c. In this manner, the lift arm control valve 20 is brought into a state where both the connection between the pump port 23 and the bottom chamber side port 21 and the connection between the pump port 23 and the rod chamber side port 22 has been cut.

In addition, the operator turns on the instruction switch 58 so as to give the controller 57 an instruction to carry out loaded travel. After that, when the vehicle velocity detection signal outputted from the vehicle velocity sensor 56 designates a vehicle velocity within the specified range for loaded travel, the controller 57 determines that the vehicle velocity is within the specified range for loaded travel, and supplies a control current to the on-off control valve 55. Thus, the on-off control valve 55 generates pilot pressure. The pilot pressure is given to the on-off valve 50 through the valve opening pilot, pipe line 53 so as to switch the valve position of the on-off valve 50 to the open position 50b. The pilot pressure is also given to the selector valve 80 through the second retained pressure discharging pilot pipe line 112 and the high pressure selecting valve 113 so as to switch the valve position of the selector valve 80 to the discharge position 80b.

In these states, the pressure in the closed-side pressure chamber 76 of the load retention valve 70 is discharged to the hydraulic oil tank 17 through the second port 82 and the tank port 83 of the selector valve 80. Till then, the pressure in the bottom chamber 11a of the lift arm cylinder 11 has been introduced into the second open-side pressure chamber 75 through the part of the bottom chamber side pipe line 15 lying between the load retention valve 70 and the bottom chamber 11a of the lift arm cylinder 11. Accordingly, the pressure in the bottom chamber 11a of the lift arm cylinder 11 introduced into the second open-side pressure chamber 75 presses and retracts the poppet 71 against the elastic force of the return spring 73. Thus, the load retention valve 70 is opened. On this occasion, the valve position of the on-off valve 50 is controlled to be the open position 50b, and the valve position on of the lift arm control valve 20 is the neutral position 20c so that the connection between the main pump 13 and the load retention valve 70 is cut. Therefore, as soon as the load retention valve 70 is opened, the pressure oil in the bottom chamber 11a of the lift arm cylinder 11 is introduced into the accumulator 40 through the load retention valve 70 and the connection pipe line 41. That is, the load retention valve 70 allows pressure oil to flow from the bottom chamber 11a of the lift arm cylinder 11 toward the accumulator 40 through the connection pipe line 41. As a result, the load pressure acting on the bottom chamber 11a of the lift arm cylinder 11 during the loaded travel is absorbed by the accumulator 40 so that vertical vibration in the working device can be suppressed.

Incidentally, till the time T1 has passed since the entrance of the vehicle velocity of the wheel loader 1 into the specified range for loaded travel, the current value I of the control current applied to the on-off control valve 55 increases gradually to I1 so that the on-off valve 50 increases its opening degree gradually (see the position of the notch in FIG. 3, and FIG. 4). In this manner, the pressure oil in the bottom chamber 11a of the lift arm cylinder 11 is prevented from flowing into the accumulator 40 suddenly. Thus, sudden lowering of the working device 2 caused by the sudden flow of the pressure oil can be suppressed. When the time T1 has passed since the travel start of the wheel loader 1, the opening degree of the on-off valve 50 increases sufficiently, and the pressure in the accumulator 40 is substantially equal to the load pressure acting on the inside of the bottom chamber 11a of the lift arm cylinder 11.

In addition, when the valve position of the on-off valve 50 is controlled so be the open position 50b, the pressure oil flows into the accumulator 40 from the bottom chamber 11a of the lift arm cylinder 11 sill the pressure in the accumulator 40 is substantially equal to the pressure in the bottom chamber 11a of the lift arm cylinder 11. Therefore, the lift arm cylinder 11 contracts in accordance with the amount of the pressure oil flowing into the accumulator 40. As described in the “(1)”, a part of the oil ejected from the main pump 13 is supplied to the accumulator 40 when the working device 2 is being raised. Accordingly, the pressure oil has been already accumulated in the accumulator before the wheel loader 1 starts the loaded travel after the lift arm cylinder 11 extends to raise the working device 2. Thus, it is possible to reduce the amount of contraction of the lift arm cylinder 11, that is, the amount of lowering of the working device 2 immediately after the valve position of the on-off valve 50 is controlled to be the open position 50b.

According to the hydraulic drive system 10 according to the embodiment, the following effects can be obtained.

In the hydraulic drive system 10 according to the embodiment, pressure oil ejected from the main pump 13 can be supplied to the accumulator 40 through the accumulator valve 61 when the working device 2 is raised. In this manner, it is possible to reduce the amount of lowering of the working device immediately after the valve position of the on-off valve 50 is controlled to be the open position during loaded travel.

In the hydraulic drive system 10 according to the embodiment, by means of the poppet 71 of the load retention valve 70, the lowering of the working device caused by leakage of the pressure oil inside the bottom chamber 11a of the lift arm cylinder 11 into the hydraulic oil tank 17 through a gab in the lift arm control valve 20 can be reliably prevented when the working device 2 is held in the raised state except during the loaded travel. In this manner, it is possible to surely prevent the working device 2 from lowering against the intention of the operator.

Further, in the hydraulic drive system 10 according to the embodiment, the poppet 84 in the selector valve 80 blocks pressure oil flowing from the first port 81 toward the tank port 83 and pressure oil flowing from the second port 82 toward the tank port 83. Accordingly, the pressure in the bottom chamber 11a of the lift arm cylinder 11 can be introduced into the closed-side pressure chamber 76 of the load retention valve 70 without leaking so as to make the introduced pressure act on the poppet 71. Thus, the poppet 71 of the load retention valve 70 can be surely held in the closed state. Thus, it is possible to contribute to prevention of the pressure oil from leaking to the lift arm control valve 20 from the load retention valve 70.

Although the hydraulic drive system 10 according to the aforementioned embodiment is applied to the working device 2 of the wheel loader 1, it may be applied to a front working device of a wheel excavator or a vessel of a dump truck.

### REFERENCE SIGNS LIST

1 wheel loader (working vehicle)
2 working device
10 hydraulic drive system
11 lift arm cylinder (hydraulic cylinder)
11a bottom chamber
11b rod chamber
13 main pump
15 bottom chamber side pipe line
16 rod side pipe line
17 hydraulic oil tank
20 lift arm control valve (control valve)
20a first operating position
20b second operating position
20c neutral position
21 bottom chamber side port
22 rod chamber side port
23 pump port
24 tank port
40 accumulator
41 connection pipe line
50 on-off valve
50a closed position
50b open position
61 accumulator valve
61a accumulation position
61b closed position
70 load retention valve
71 poppet
73 return spring
74 first open-side pressure chamber
75 second open-side pressure chamber
76 closed-side pressure chamber
80 selector valve
80a supply position
80b discharge position
81 first port
82 second port
83 tank port
84 poppet

1. A hydraulic drive system for a working vehicle, comprising:
a hydraulic cylinder including a bottom chamber to which pressure oil is supplied to raise a working device of the working vehicle, and a rod chamber to which pressure oil is supplied to lower the working device;
a main pump which elects pressure oil for driving the hydraulic cylinder;
a control valve which consists of a spool valve including a bottom chamber side port connected to the bottom chamber through a bottom chamber side pipe line, a rod chamber side port connected to the rod chamber through a rod chamber side pipe line, a pump port connected to the main pump, and a tank port connected to a hydraulic oil tank;
an accumulator which is connected to an end portion of a connection pipe line branching from the bottom chamber side pipe line;
an on-off valve which is provided on the connection pipe line; and
an accumulator valve which is provided on an accumulation bypass pipe line which has opposite ends connected to the connection pipe line and which is located to bypass the on-off valve so that the accumulator valve is arranged in parallel with the on-off valve; so that
the control valve is arranged to be switchable among a first operating position which is a valve position where the pump port is connected to the bottom chamber side port and the rod chamber side port is connected to the tank port, a second operating position which is a valve position where the pump port is connected to the rod chamber side port and the bottom chamber side port is connected to the tank port, and a neutral position in which both the connection between the pump port and the bottom chamber side port and the connection between the pump port and the rod chamber side port are cut;
the on-off valve is arranged to be switchable between an open position which is a valve position where the connection pipe line is opened to connect the bottom chamber to the accumulator, and a closed position which is a valve position where the connection pipe line is closed to cut the connection between the bottom chamber and the accumulator, the valve position being controlled to be switched toward the open position from the closed position during loaded travel in which the working vehicle travels while the working device is held in a raised state, the valve position being controlled to be the closed position at any time except during the loaded travel; and
the accumulator valve is arranged to be switchable between an accumulation position which is a valve position where pressure oil is allowed to flow toward the accumulator in the accumulation bypass pipe line, and a closed position which is a valve position where the accumulation bypass pipe line is closed to block the pressure oil flowing into the accumulator, the valve position being controlled to be the accumulation position when the pressure oil ejected from the main pump is supplied to the bottom chamber through the control valve and the bottom chamber side pipe line and when pressure in the accumulator is lower than predetermined pressure; wherein:
a load retention valve is provided on the bottom chamber side pipe line, the load retention valve consisting of a poppet valve, which allows pressure oil to flow from the control valve to the bottom chamber through the bottom chamber side pipe line when the valve position of the control valve is the first operating position, allows pressure oil to flow from the bottom chamber to the control valve through the bottom chamber side pipe line when the control valve is in the second operating position, allows pressure oil to flow from the bottom chamber to the accumulator through the connection pipe line when the loaded travel is carried out, and blocks pressure oil flowing from the bottom chamber to the control valve through the bottom chamber side pipe line by means of a poppet when the valve position of the control valve is the neutral position except during the loaded travel.

2. A hydraulic drive system for a working vehicle according to claim 1, wherein:
the load retention valve includes a return spring which urges the poppet to close, a first open-side pressure chamber in which pressure to open the poppet against an elastic force of the return spring is introduced from the bottom chamber side port side of the control valve, a second open-side pressure chamber in which pressure to open the poppet against an elastic force of the return spring is introduced from the bottom chamber side of the hydraulic cylinder, and a closed-side pressure chamber in which pressure oil to press the poppet to close the poppet is introduced between the load retention valve and the bottom chamber in the bottom chamber side pipe line; and
a selector valve is provided to lie between the bottom chamber side pipe line and the closed-side pressure chamber of the load retention valve, and the selector valve includes a first port connected to the bottom chamber side pipe line between the load retention valve and the bottom chamber, a second port connected to the closed-side pressure chamber, and a tank port connected to the hydraulic oil tank, and is arranged to be switchable between a supply position which is a valve position where the first port is connected to the second port while pressure oil flowing toward the tank port from the first and second ports is blocked by the poppet, and a discharge position which is a valve position on where the second port is connected to the tank port, the valve position of the selector valve being controlled to be the supply position when the valve position of the control valve is the neutral position except during the loaded travel or when the valve position of the control valve is the first operating position, the valve position of the selector valve being controlled to be the discharge position during the loaded travel or when the valve position of the control valve is the second operating position.
